(19) United States
(12) Patent Application Publication
(10) Pub. No.: US 2008/0264802 A1
(43) Pub. Date: Oct. 30, 2008

(54) Testing Method for Precious Metals

(76) Inventors: Kui Lim Tam, Singapore (SG); Ketsuwan Pramote, Bangpoon Muang Pathumthani (TH)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/884,523

(22) PCT Filed: Dec. 20, 2006
(86) PCT No.: PCT/SG06/00397

§ 371 Date: Aug. 16, 2007

(30) Foreign Application Priority Data
Dec. 20, 2005 (SG) 200508244-1

(51) Int. Cl. G01N 27/26

(52) U.S. Cl. 205/790; 204/434

(57) ABSTRACT

A precious metal assay method which includes the steps of forming an electrolytic cell comprising an anode specimen and a reference cathode, driving a ramp input into the electrolytic cell, measuring a resulting current through the electrolytic cell over a period of the ramp input. The assay value may be determined by comparing the locality, slope and peak or area of a current response of the resulting current against the localities, slopes and peaks or areas of a list of current responses of known precious metal compositions from an empirical look-up table and displaying the assay value on an electronics display.

### FIELD OF THE INVENTION

The present invention relates generally to a testing method for assaying precious metals.

### BACKGROUND OF THE INVENTION

There are various quantitative techniques to assay precious metals, in particular gold, including spectrometric, calorimetric and gravimetric techniques. One of the more commonly used technologies to assay gold is based on electro-chemistry. Unlike the other techniques which are generally too complex, expensive or bulky to be used by most jewelers, the electro-chemical technique provides an easy and relatively inexpensive solution to assay gold.

For example, in the teaching of Medvinsky et al. of U.S. Pat. No. 4,799,999, an electrochemical process is used whereby a specimen is wetted by a described electrolyte and a small current anodizes the surface of the specimen. An external electronic measuring instrument is then applied to the charged surface, and potential difference decay is observed, tracked and analysed by the external measuring instrument. This process, while capable of reporting accurate results, is limited to the lower end of the karatage scale, for example, at a range between 6 and 14-karat. The technique does not respond significantly to gold alloy of higher karatage, for example, between 14 and 24 karat.

In another teaching of Medvinsky of U.S. Pat. No. 5,218,303, an electro-chemistry method which involves driving a series of low electric current pulses through a specimen which is wetted by an electrolyte to form an electrolytic paste is disclosed. The method involves measuring the instantaneous conductance of the electrolytic paste and comparing and interpolating the measured conductance against an empirical table of conductance standards. Although this method is said to be capable of measuring gold alloy at higher purity of between 14 and 24 karat, this technique may not be sufficiently reliable to provide accurate measurement of gold in the low and mid range scale.

The accuracy of the various gold assay methods in the market is limited to measurement at either a low end or a high end of the karatage scale. While a gold assaying method may be used to measure gold of high purity, the same method may lose its sensitivity when applied to measure gold of low purity. The reverse is also true whereby a method for measuring low purity gold may not be suitable to measure gold of high purity.

It is therefore desirable to provide an electro-chemical method for fast and accurate assaying of gold that preferably covers the broad spectrum of the karatage scale.

### SUMMARY OF THE INVENTION

In accordance with one aspect of the present invention, there is provided a method for assaying precious metals comprising the steps of:
(a) forming an electrolytic cell which includes an anode specimen and a reference cathode;
(b) driving a ramp input into the electrolytic cell;
(c) measuring a resulting current through the electrolytic cell over a period of the ramp input; and
(d) determining an assay value for the specimen based on measurement of said resulting current.

The assay value may be karatage or some other value relating to the purity or the amount of precious metal in a specimen.

The assay value may be based on locality of an input current response of the specimen. The assay value may be found by comparing or interpolating the locality of the input current response against the localities of a list of current responses of known precious metal compositions, which may be stored in a look-up table.

Alternatively, the assay value may be based on a slope or peak value of an input current response of the specimen. The assay value may be found by comparing or interpolating the results of the assay, for example, a maximum slope and peak of the input current response against the maximum slopes and peaks of a list of current responses in a look-up table, the look-up table being determined based on empirical data for specimens of known karatage or the like.

Alternatively, the assay value may be based on an integration of the resulting current, and may be based on the electrical charge that flows through the cell during the ramp input. Preferably, the integration is over the whole of the ramp input period, although other periods during the ramp input may also be used. Other cell current characteristics, e.g. current values at certain times in the ramp input, may also be used to determine assay values.

In an alternative embodiment of the invention, the assay value may be found by comparing the results of the assay, e.g. total electrical charge flow, with values in a look-up table, the look-up table being determined based on empirical results for specimens of known karatage or the like. The assay value may be determined by interpolating the look-up table values, where necessary. Alternatively, the assay results could be input into an assay value formula that relates total electrical charge or the like to assay values and that is determined from empirical findings.

Preferably, the precious metals assay method comprises the step of driving a ramp input through the anode specimen to initiate an electrolytic reaction.

Preferably, the precious metals assay method comprises the step of driving a ramp input for a duration of between about 6 to about 8 seconds.

Preferably, the precious metals assay method includes a ramp input duration which is about 7 seconds.

Preferably, the precious metals assay method includes a ramp input which comprises a voltage in a triangular-shaped waveform.

Preferably, the precious metals assay method includes a ramp input having a peak which is in a range of between about 4.5V to about 5.0V.

Preferably, the precious metals assay method includes a ramp input having a peak of about 4.8V.

In one embodiment, the ramp input may ramp up and then ramp down. The period of the ramp down may be equal to that of the ramp up period.

The ramp input may begin from a voltage corresponding to a steady state open circuit voltage measured across the electrolytic cell.

In accordance with a further aspect of the present invention, there is provided precious metal assaying apparatus comprising:

an anode and cathode for forming an electrolytic cell with a specimen that is to be assayed; and

electronic testing circuitry associated with the anode and cathode for determining an electrical characteristic of the cell;

wherein the circuitry comprises a driver for applying a ramp voltage to the cell, and a monitoring circuit for measuring the resulting current flowing through the cell during the application of the ramp voltage.

### BRIEF DESCRIPTION OF THE DRAWINGS

FIG. 1 shows the left side view of a preferred embodiment of a testing device;

FIG. 2 shows a block diagram of a preferred embodiment of electronic circuitry used in the testing device;

FIG. 3 shows a graph of a ramp input in accordance to one embodiment of the invention;

FIG. 4a shows a superimposed graph comprising regions for gold alloys of different karatages;

FIGS. 4b to 4h show graphs depicting locality of different regions for gold alloys of different known karatages;

FIG. 5a shows a superimposed graph comprising current responses for gold alloys of various karatages over a ramp input;

FIGS. 5b to 5g show graphs comprising individual current response for each gold alloy of different known karatage over a ramp input;

FIG. 6a shows a superimposed graph comprising current responses for gold alloys of various known karatages over the period of a ramp input;

FIGS. 6b to 6g show graphs comprising individual current response for each gold alloy of different known karatage over the period of a ramp input;

FIG. 7 shows a graph of an alternative ramp input.

### PREFERRED EMBODIMENTS OF THE INVENTION

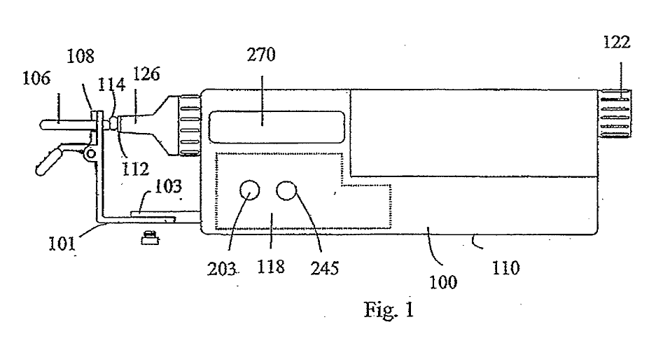

The testing device 100 as shown in FIG. 1 comprises an anode probe 103, a reference cathode probe 112, and an electronic circuit board 118 which is enclosed within a housing 110 and includes assay testing circuitry thereon. The cathode probe 112 is preferably made of platinum and may be connected to ground, e.g. an analog ground. Alternatively, the cathode probe 112 may be connected to a reference voltage.

The anode probe 103 may be coupled to a first surface of a specimen 106, e.g. a ring, to form an anode specimen. Coupling may, for example, be through a spring clip 108 of a specimen holder 101 or, alternatively, through a crocodile clip cable.

A controlled quantity of electrolytic gel 114 may be discharged onto a second surface of the specimen 106 through a nozzle 126 by rotating a knob 122 that actuates an actuator, such as for example a plunger of a gel dispenser, to dispense the electrolytic gel. The electrolytic gel is typically a mixture of acidic and salt solution, for example, 1.25% acid with 0.05% chloride salt. Preferably, hydrochloride acid is used although other types of acid such as sulfuric acid may also be used. The solution is further mixed with soft gel.

The cathode probe 112 should generally be positioned adjacent the nozzle 126, and configured so that in use, the cathode probe is able to make electrical contact with specimen 106 via electrolytic gel 114 dispensed from the nozzle 126.

The discharged electrolytic gel 114 creates a wet junction that physically and electrically links the second surface of the anode specimen to the cathode probe 112. The specimen 106, anode probe 103, electrolytic gel 114 and the cathode probe 112, when electrically interconnected, form an electrolytic cell 201 whose electrical characteristics may be analysed to assay the specimen 106.

The testing device 100 may take the form that for example is described in co-pending Singapore patent application no. 200507368-9, entitled “A Testing Device for Precious Metals” which is filed on 11 Nov. 2005, the contents of which are incorporated herein by reference in their entirety.

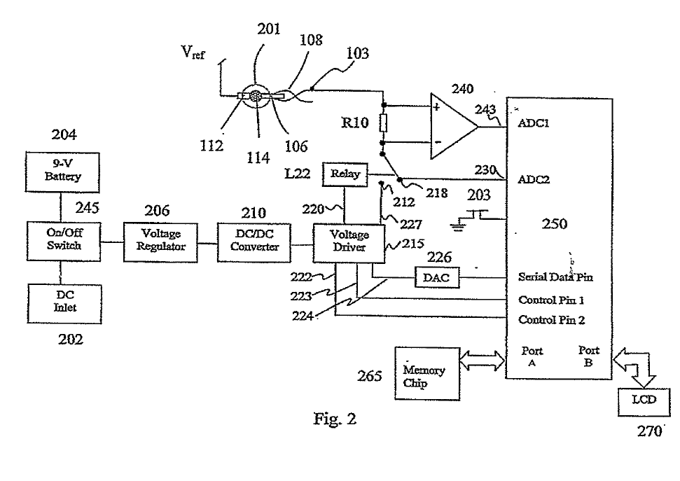

The circuit board 118 may be powered by either a DC inlet 202 or a 9-V battery 204 as shown in FIG. 2. The power source is coupled to the circuitry of the circuit board 118 through an ON/OFF switch 245. A voltage regulator 206 and a DC/DC converter 210 may also be provided to supply a stable set of voltages for the operation of different microchips on the circuit board 118 or to act as reference voltages.

The circuitry of the circuit board 118 may comprise for example, a microprocessor 250, a memory chip 265, a differential amplifier 240 and a voltage driver 215. Preferably, the circuitry is constructed of microchips or other small circuit components so that it may be easily integrated within the small and compact housing 110 that may be easily carried in one's hand.

The driver 215 is used to provide a controlled ramp input signal to the electrolytic cell 201. The driver 215 may comprise, for example, an IC based voltage generator. Alternatively, discrete components may be used to construct the driver 215. The driver 215 may be controlled by a plurality of input lines 222, 223 and 224, which are connected to driver 215 from the microprocessor 250.

For example, input lines 222 and 223 may carry command signals to selectively enable or disable the driver 215 and its output lines 220 and 227. Input line 224 may carry data information to control the generation of the ramp input signal. Typically, the data information from line 224 is an analog signal which is converted from the digital serial output of the microprocessor 250 through a D/A converter 226.

The first output line 220 of the driver 215 is connected to a relay L22. The relay L22 may be configured to selectively switch between connecting the electrolytic cell 201 to a line 230 of the microprocessor 250 through a normally closed switch 218. Alternatively, the relay L22 may switch the connection of the electrolytic cell 201 to the second output line 227 of the driver 215 through a normally open switch 212.

When the relay L22 is activated by the driver 215, through for example setting line 220 to high by controlling the command lines 222 and 223, the normally open switch 212 is closed. This connects the output 227 of the driver 215 to the electrolytic cell 201. The activation of relay L22 also simultaneously disconnects the normally closed switch 218 and thereby decouples the electrolytic cell 201 from its connection to line 230 of the microprocessor 250. When connected to the electrolytic cell 201, the microprocessor 250 may instruct the driver 215 to generate and provide a controlled ramp input signal to the cell through the output line 227.

When the relay L22 is deactivated by the driver 215 through for example setting line 220 to low by controlling the command lines 222 and 223, the normally open switch 212 is disconnected, thereby disconnecting the output 227 of the driver 215 from the electrolytic cell 201. The deactivation of relay L22 also restores the switch 218 to its normally closed position, thereby connecting the electrolytic cell 201 to line 230 of the microprocessor 250.

A current measuring resistor R10 is connected in series to the electrolytic cell 201 and current passing through the resistor R10 is amplified by the differential amplifier 240. A first end of the resistor R10 may be inputted to an inverting terminal of the differential amplifier 240 while a second end of the resistor R10 may be inputted to a non-inverting terminal of the differential amplifier 240. The output 243 of the differential amplifier 240 may be connected to a first A/D converter ADC1 of the microprocessor 250.

When a new measurement cycle is initiated by, for example, pushing a reset switch 203, the microprocessor 250 may begin the cycle by disabling the relay L22 and thereby connecting the electrolytic cell 201 to the microprocessor 250.

The microprocessor 250 will detect an initial steady state open circuit voltage Vᵢₙᵢₜ across the electrolytic cell 201 through line 230. The line 230 connects the anode probe 103 of the electrolytic cell 201 to an A/D converter ADC2 of the microprocessor 250. Depending on the design of the electrical circuitry, the cathode probe 112 may be connected to a reference voltage or to an analog ground.

If the cathode probe 112 is connected to a reference voltage, the open circuit voltage of the electrolytic cell 201 may be determined by, for example, offsetting the measured voltage of the anode probe 103 from the reference voltage. If the cathode probe 112 is connected to an analog ground, the voltage of the anode probe 103 is read directly as the open circuit voltage of the electrolytic cell 201.

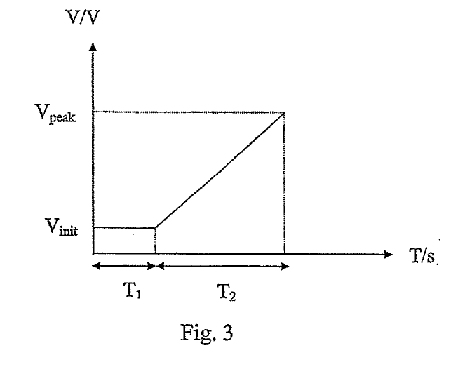

Upon detecting a steady state open circuit voltage Vᵢₙᵢₜ as shown in FIG. 3, e.g. for at least a first time period T₁, the microprocessor 250 activates the relay L22 to switch the connection of the electrolytic cell 201 from the microprocessor 250 to the output 227 of the driver 215 so that a ramp input signal may be applied. The ramp input signal may be inputted into the electrolytic cell 201 via the anode probe 103.

The ramp input signal which is preferably a triangular-shaped waveform voltage is generated by the driver 215 from an initial value of Vᵢₙᵢₜ and ramps-up to reach a peak voltage Vₚₑₐₖ within a ramping period of T₂ seconds. A ramp input of other shapes, such as for example a curve may also be used. The peak voltage Vₚₑₐₖ may vary and is limited by the equation Vₚₑₐₖ=V_{ref}+2.2V. Preferably, Vₚₑₐₖ ranges between 4.5V to about 5.0V. In this embodiment, the peak voltage Vₚₑₐₖ is set around 4.8V.

The voltage causes an electrolytic reaction within the electrolytic cell 201, which may be an oxidation or reduction of alloyed metals of the specimen 106. The reaction releases free ions into the electrolytic gel 114 which results in increased conductivity of the electrolytic gel. These free ions are released by impurities from gold alloy of specimen 106. Gold is slightly oxidized due to its stability in the reactivity series. However, the main contributor of the free ions is from the impurities of the gold alloy. A higher amount of gold in the alloy specimen 106 would result in lower conductivity through the electrolytic gel.

The duration of ramp input T₂ may vary but is preferred to be between about 5 to about 8 seconds and even more preferably, at about 7 seconds. The short exposure time of the specimen 106 to the acidic electrolyte advantageously ensures that no destruction or damage is caused to the specimen during measurement.

At the end of T₂, the ramp input signal is cut-off. The microprocessor 250 may then issue a command to deactivate the relay L22 and to restore the connection of the electrolytic cell 201 from the driver 215 to line 230 of the microprocessor 250.

During the ramping period T₂, a resulting current passing through the resistor R10 is amplified by the differential amplifier 240. The magnitude of the resulting current is dependent on the level of free ions discharged by the non-gold alloy metals in the specimen 106 during the ramp input T₂. The analog resulting current from the differential amplifier 240 are inputted into the ADC1 of the microprocessor 250 and is converted into digital values.

The digitized resulting current samples are used by the microprocessor 250 to determine an assay value for the specimen 106.

In one embodiment of the invention, the current samples are processed by the microprocessor 250 to map out a current response for the test specimen 106 over the voltage ramp input.

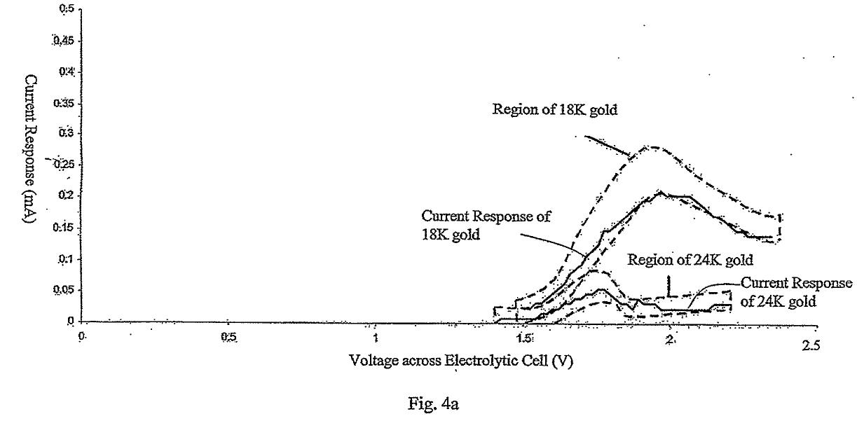

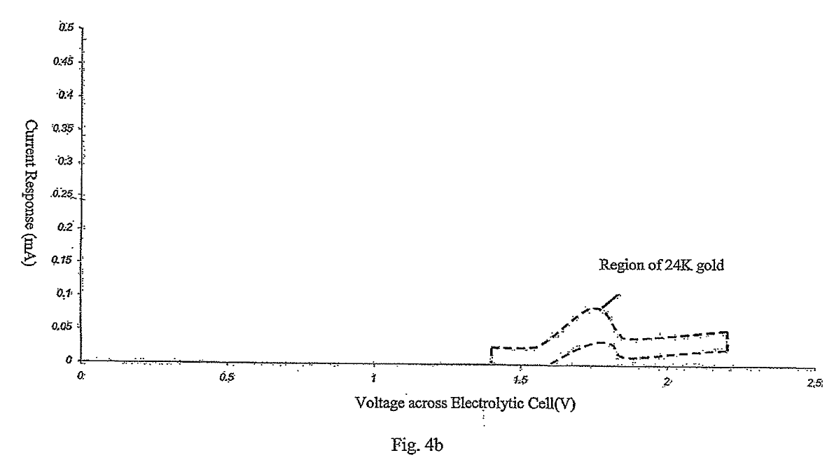

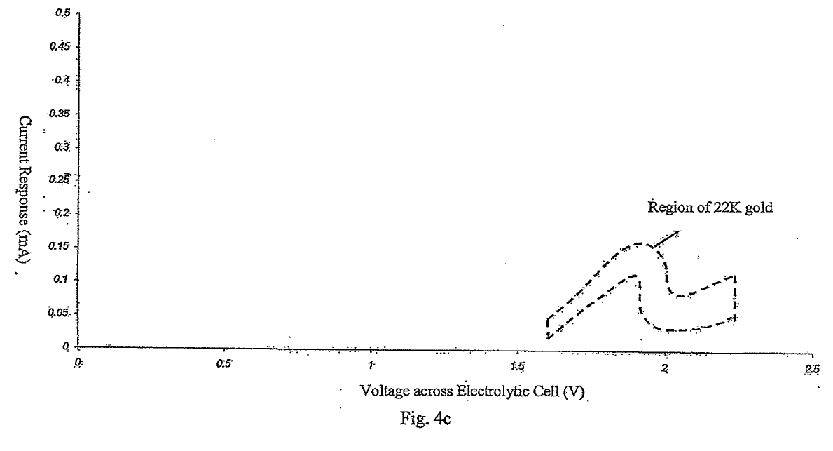

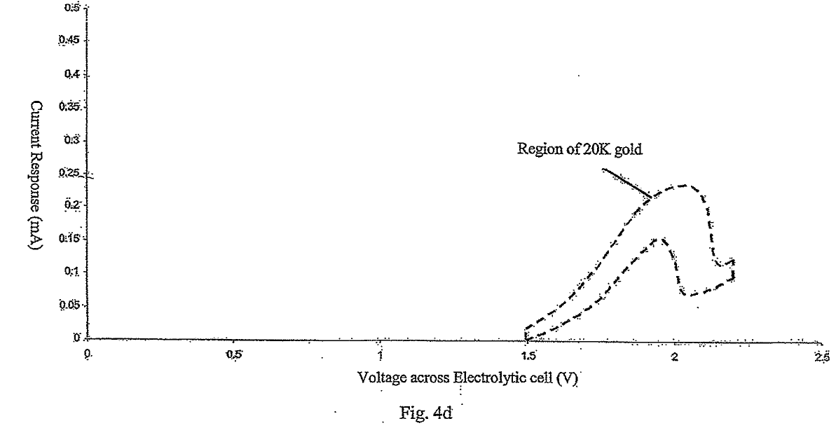

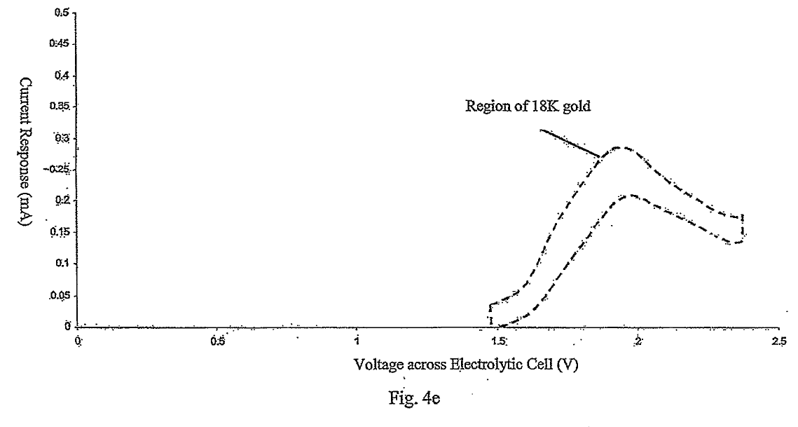

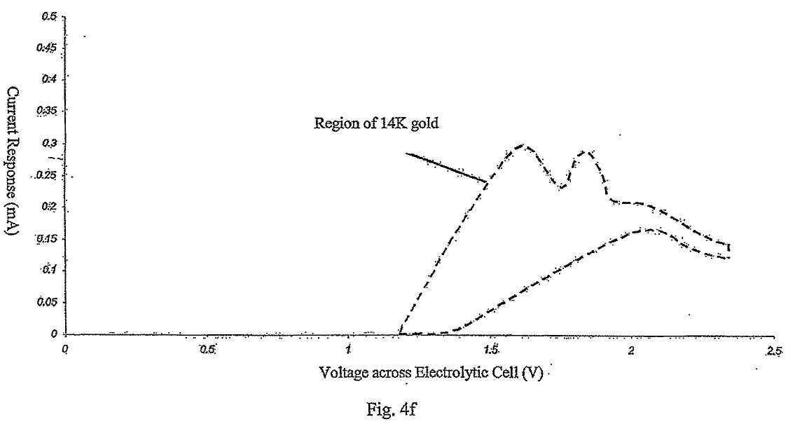

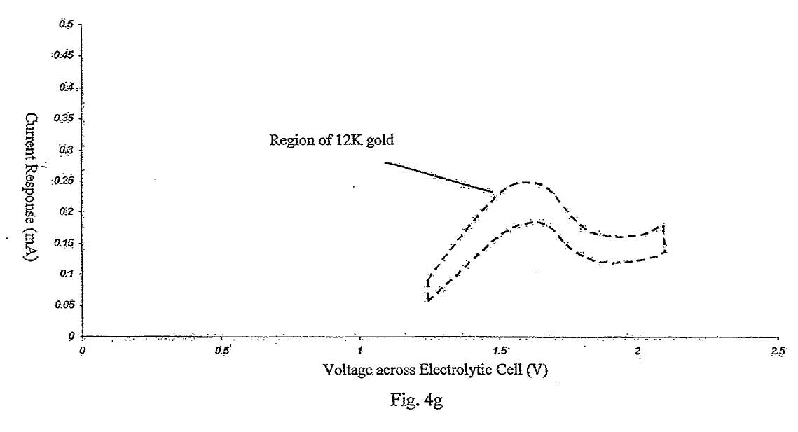

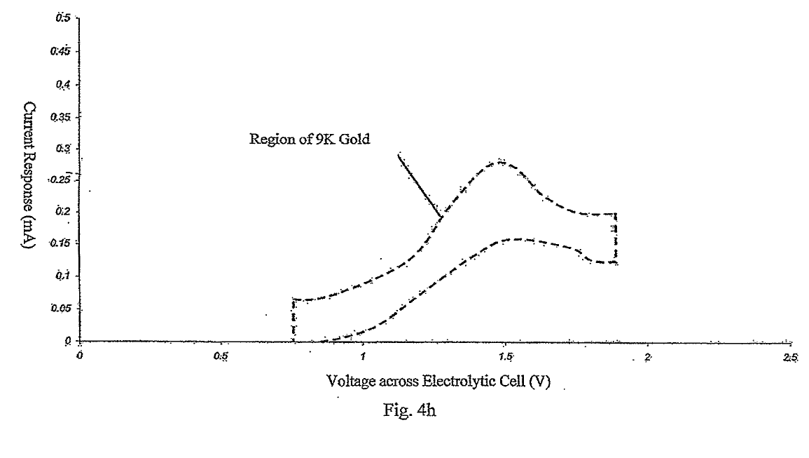

The locality of the current response is compared to a list of regions stored in a look-up table. Each region in the look-up table is assigned a corresponding value, which may for example, reflects the purity of a precious metal such as gold. As shown in FIG. 4a, specimens of different karatage values would yield different current responses. A plurality of regions, such as for example, a region of 24 karat gold, a region of 22 karat gold, a region of 20 karat gold and etc may be mapped out based on experimentation as shown in FIGS. 4b to 4h, with each region corresponds to a known karatage value.

The locality information related to each region and a corresponding karatage value may be arranged in an empirical look-up table and may be stored in the memory chip 265 which may be downloaded into the microprocessor 250 during power-up.

The purity of the specimen 106 may be determined by, for example, comparing the locality of the current response formed by the current samples of the measured specimen 106 against the localities of the list of regions provided in the look-up table. If the current samples of the current response are concentrated within one of the listed regions, a match is found and the corresponding value of the matched region is read out. The assay value may then be transmitted to an electronic display 270, such as for example, a LCD for read out.

Alternatively, the assay value of the specimen 106 may also be determined by interpolating the location of the current response situated between two listed regions in the look-up table to obtain a corresponding assay value if a match is not found. For example, an assay value of the specimen 106 which is located between the region of 9K and 12K may be determined through interpolation.

The look-up table may be created by collating the current samples of various specimens of known purity over the voltage ramp input. The region of a known specimen may be mapped out by taking the area between the upper and lower bands of the current response of the known specimen. The region may then be adjusted further to fine tune the accuracy of the mapping through experimentation. The karatage value of the known specimen is assigned to this region. This process is repeated in the same manner for different specimens of known compositions to form the look-up table.

In another alternative embodiment of the invention, other input characteristics of the current response from the test specimen 106 over the voltage ramp input are determined by the microprocessor 250. These input characteristics may include, for example, the slope (preferably a maximum slope) and peak (preferably a maximum turning point) of the current response. These input characteristics are compared to a set of recorded characteristics for known alloy compositions in an empirical look-up table, as shown for example in Table 1, which may be stored in the memory chip 265.

TABLE 1

| Purity (karat) | Maximum Slope | Peak (mA) |
|---|---|---|
| 9 | 1.5 to 1.6 | 8.45 to 9.07 |
| 14 | 1.8 to 2.6 | 8.55 to 8.83 |
| 18 | 0.4 to 0.8 | 8.26 to 9.92 |
| 20 | 0.9 to 1.8 | 7.46 to 8.26 |
| 22 | 1.8 to 2.2 | 6.89 to 7.56 |
| 24 | 2.1 to 2.6 | 6.38 to 6.85 |

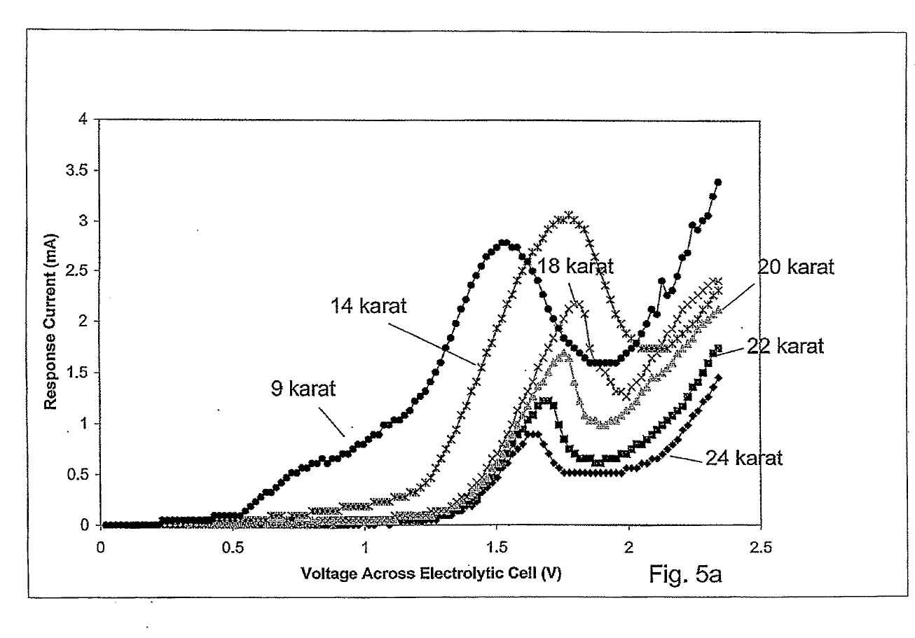

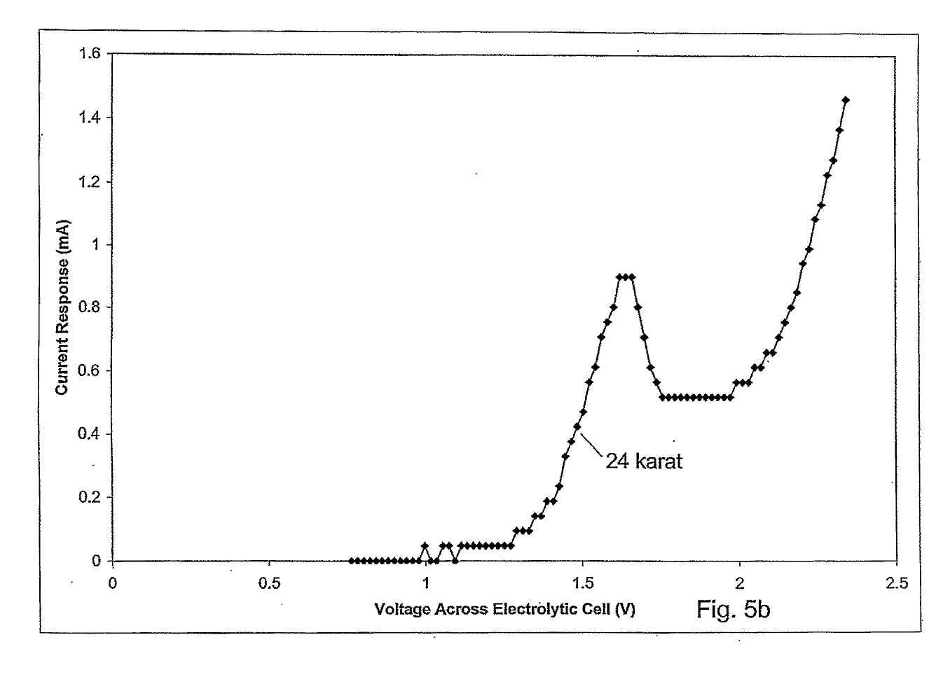

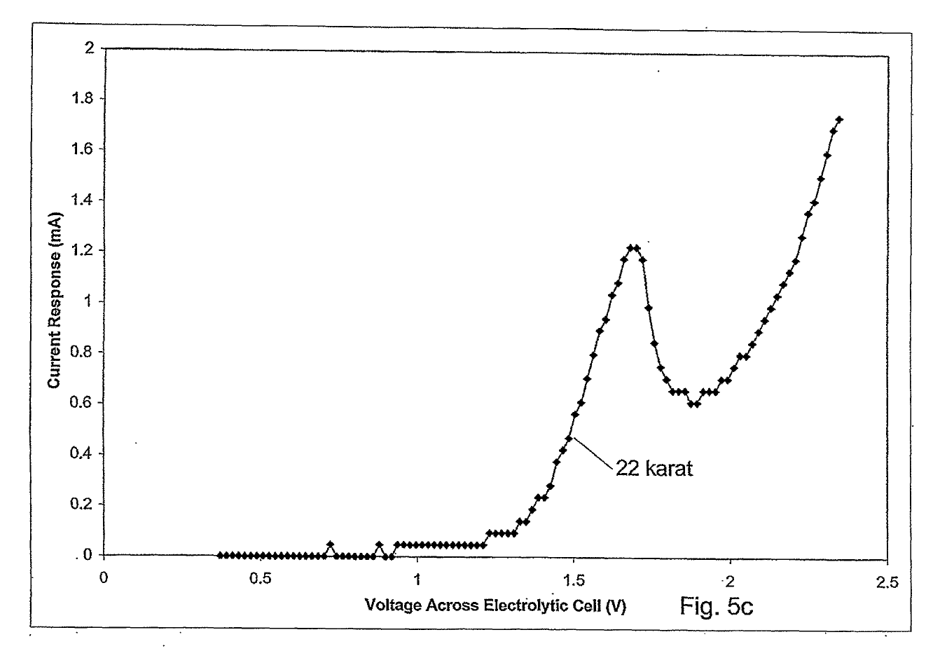

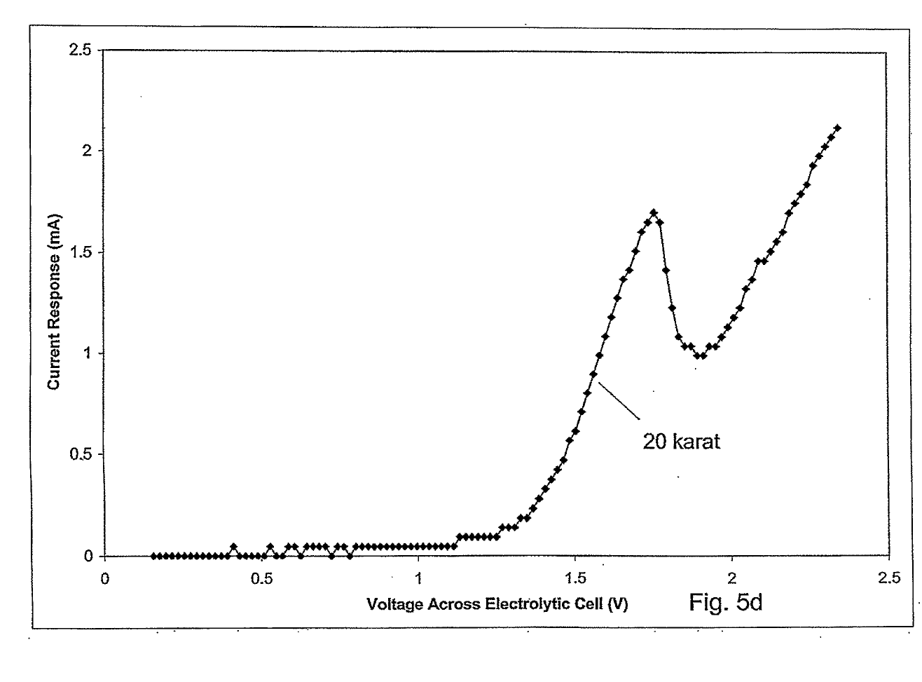

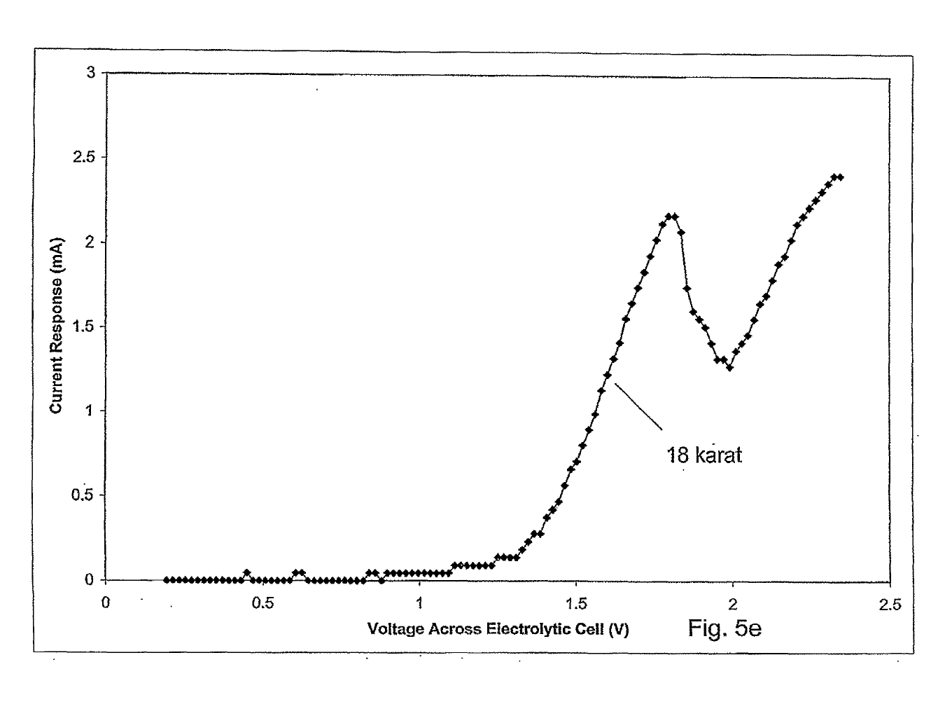

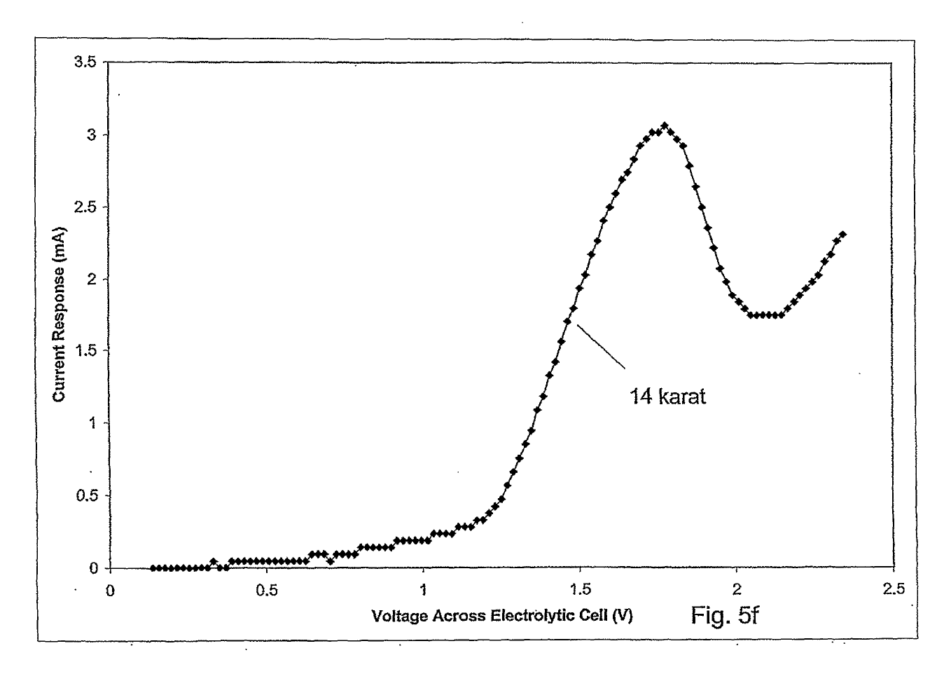

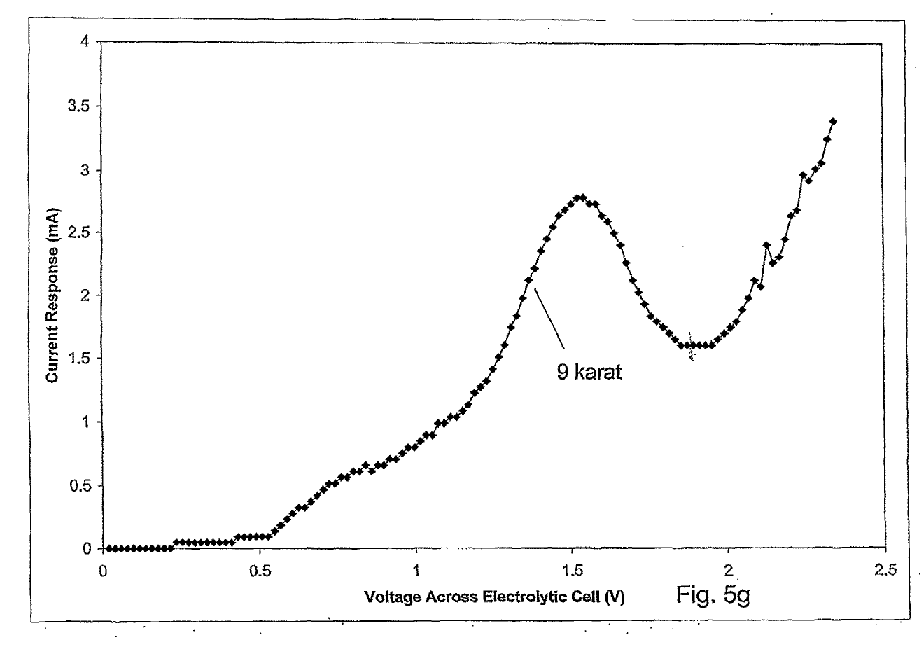

The look-up table may be created by collating the characteristics of current responses of various specimens of known purity over the voltage ramp input as shown for example by the graphs in FIGS. 5a to 5g. Preferably, a range of values is provided for the maximum slope and peak of each current response to correspond to a karatage value and the range may be fine tuned for greater accuracy through experimentation. This process is repeated in the same manner for different specimens of known compositions to form the look-up table.

The microprocessor may also perform an interpolation between two nearest available values in the look-up table if an exact measured input characteristic is not found in the table.

In yet another alternative embodiment of the invention, the current samples are used by the microprocessor to work out an area beneath a current curve over the period T₂ of the ramp input.

The calculated area represents the total electrical charges of the resulting current during the period T₂ of the ramp input signal. The calculated area is compared to a set of electrical charges for known alloy compositions in an empirical look-up table, as shown for example in Table 2, which may be stored in the memory chip 265.

TABLE 2

| | Charge |
|---|---|
| Purity (karat) | (milliCoulomb) |
| 9 | 13.709 to 15.087 |
| 14 | 9.907 to 12.082 |
| 18 | 7.133 to 7.893 |
| 20 | 6.153 to 6.486 |
| 22 | 4.127 to 4.540 |
| 24 | 2.685 to 3.454 |

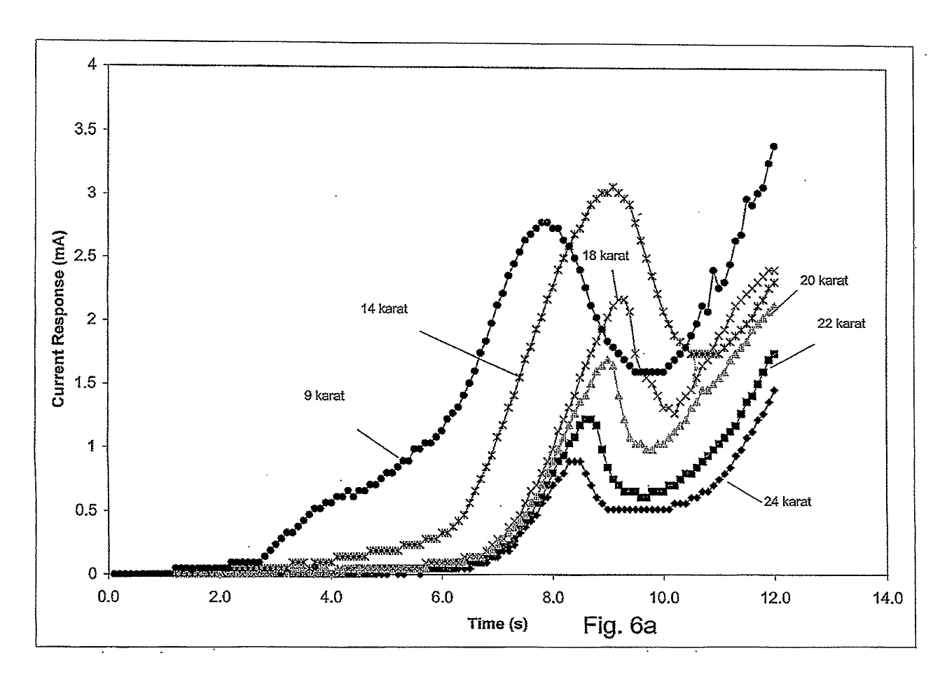

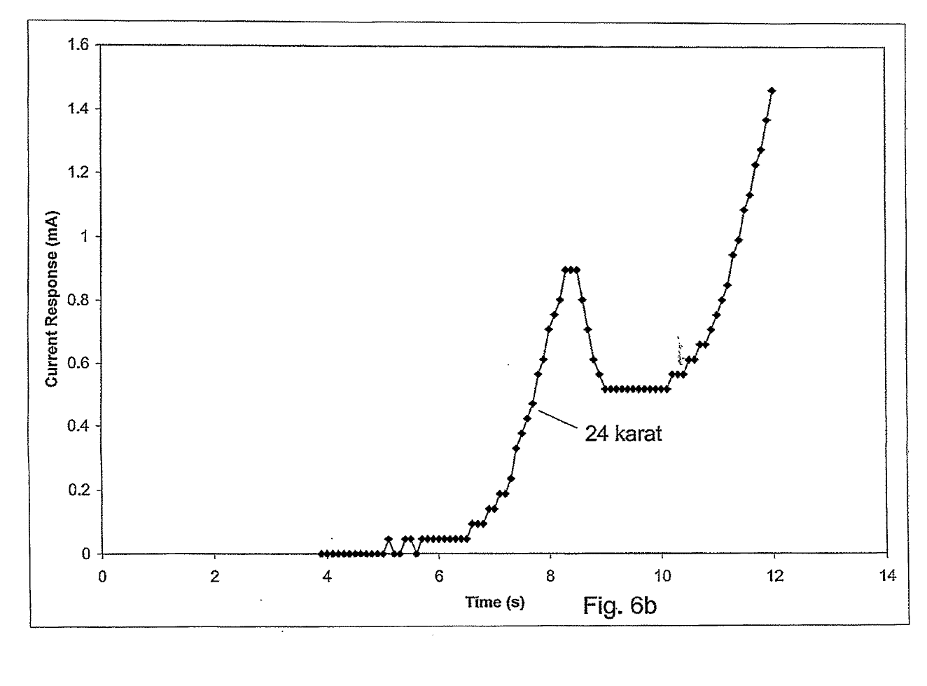

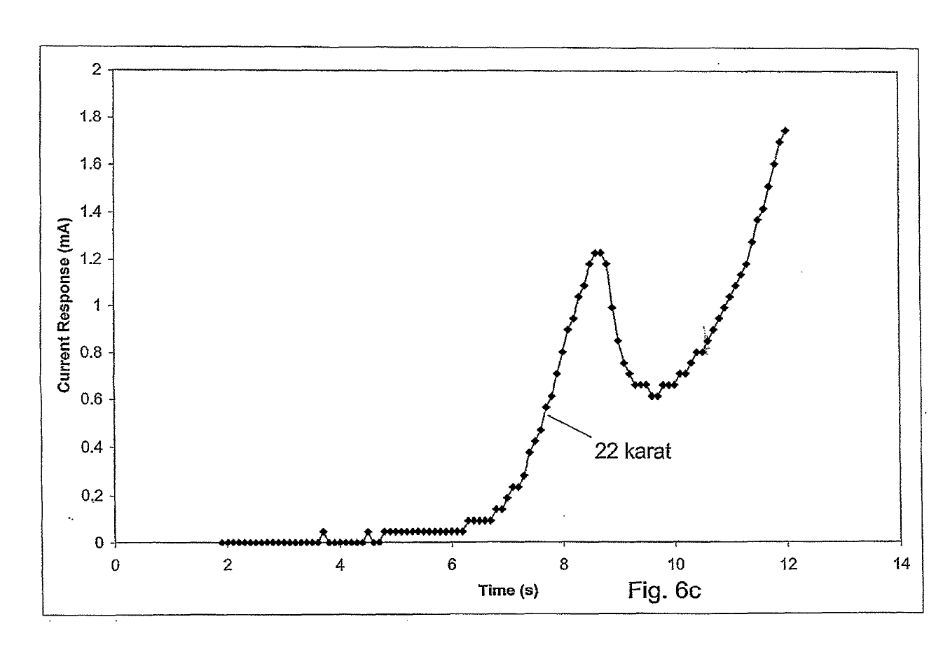

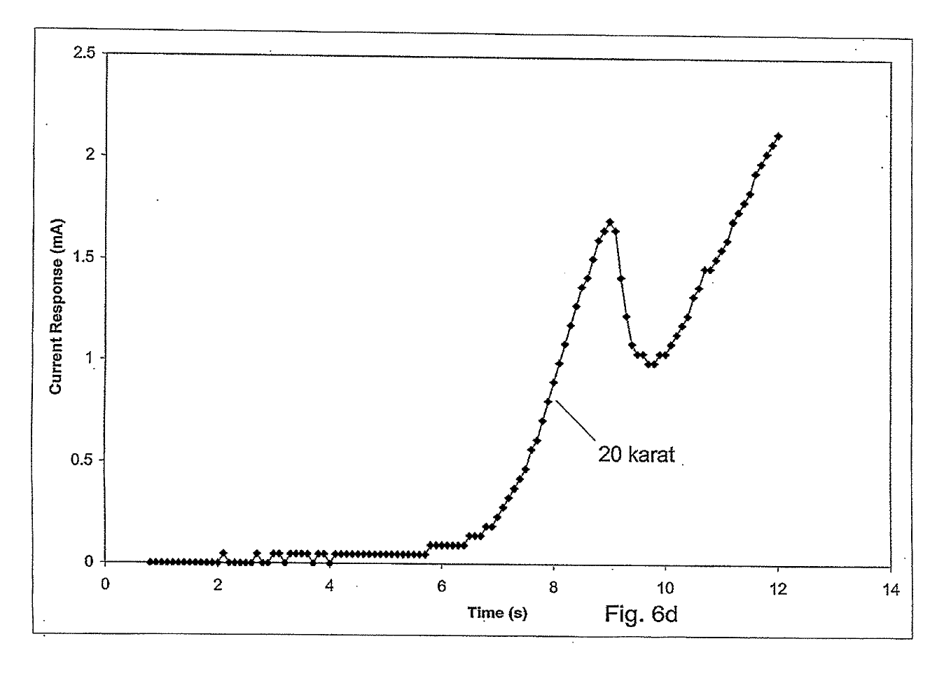

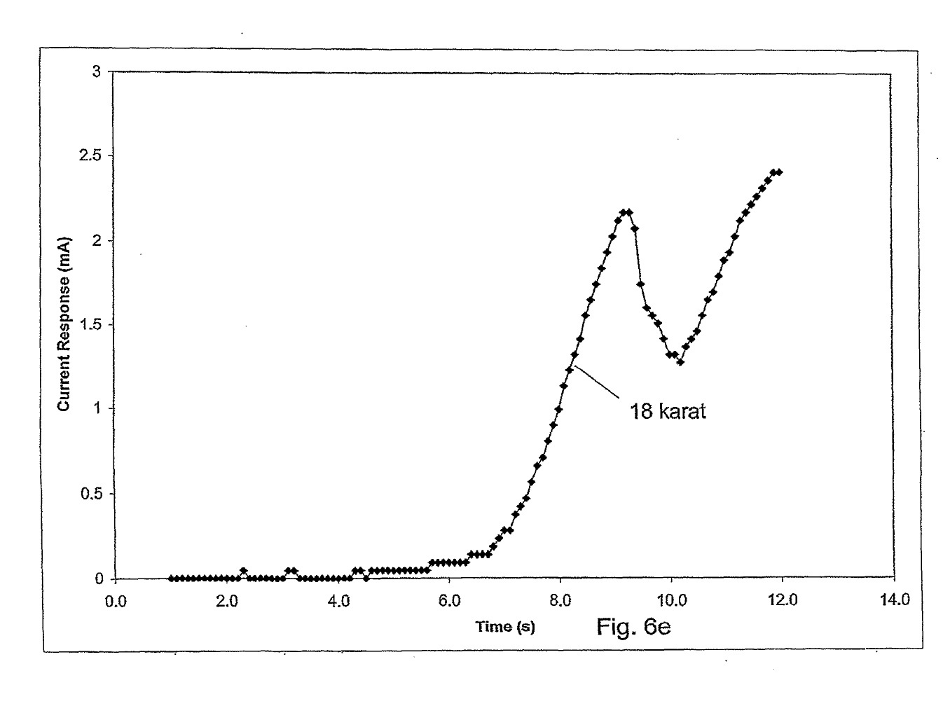

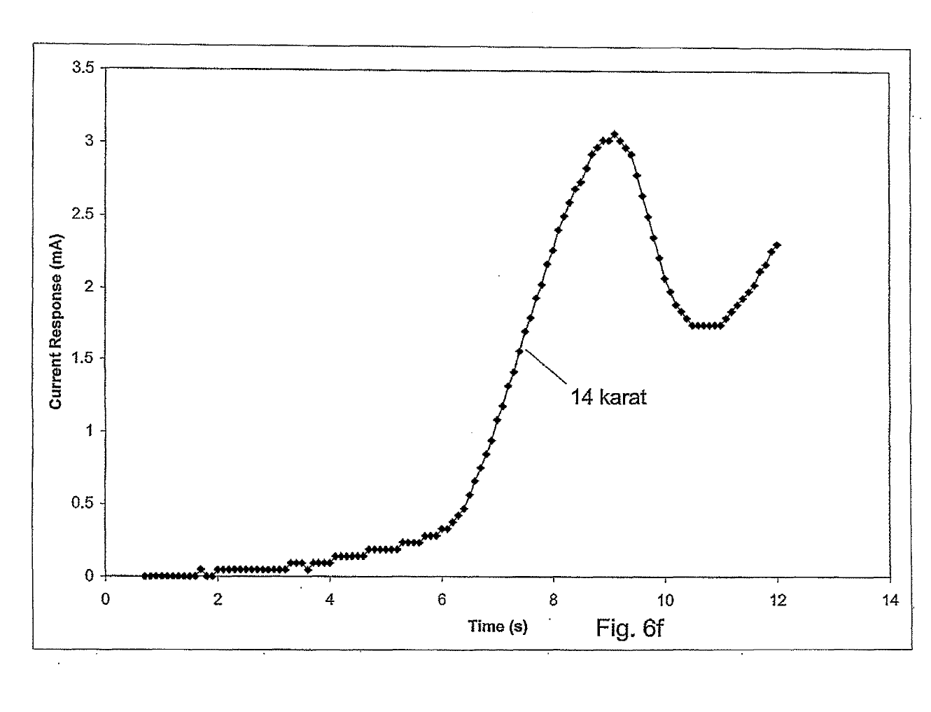

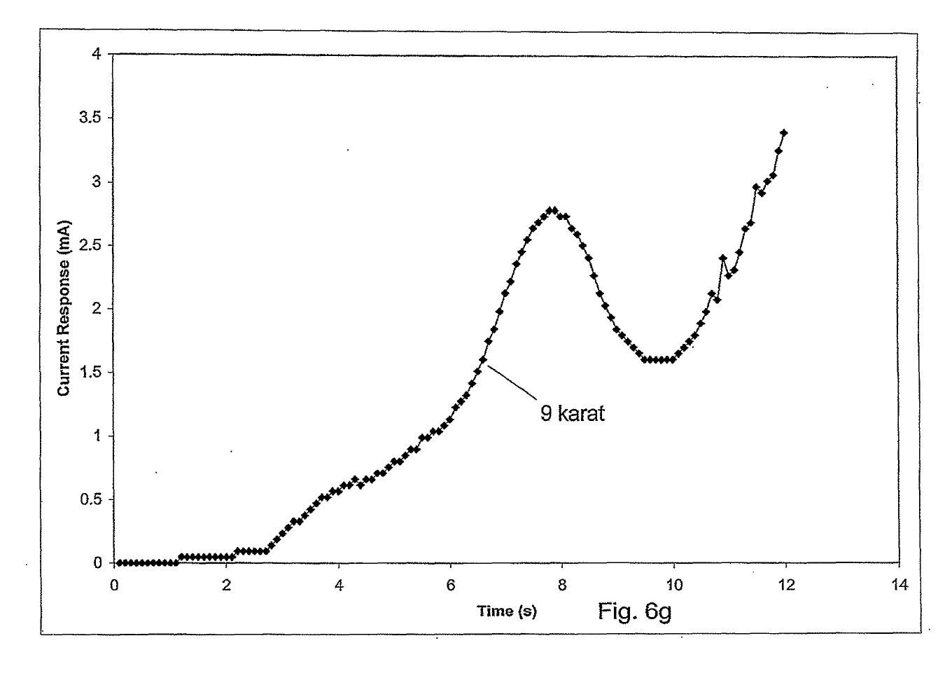

The look-up table may be created by collating the data of electrical charges of different samples of known purity for the duration of the ramp input, as shown for example in FIGS. 6a to 6g. A range of area may be provided to correspond to a karatage value and the range may be fine tuned for greater accuracy through experimentation.

The microprocessor 250 may compare the electrical charge of a measured specimen against the look-up table to find a corresponding value which may, for example, reflect the purity of gold in the specimen 106. The microprocessor may also perform an interpolation between two nearest available values in the look-up table if an exact measured input value is not found in the range listed in the table. The corresponding value or the interpolated value may then be transmitted to an electronic display 270, such as for example a LCD for read out.

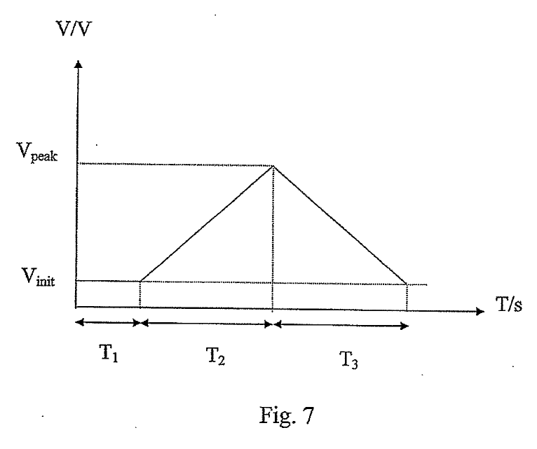

In another alternative embodiment of the invention, the ramp input may be ramped down from Vₚₑₐₖ to Vᵢₙᵢₜ over a period of T₃ as shown in FIG. 7. The ramp input into the electrolytic cell 201 is cut-off after a total duration of T₂+T₃. Preferably, the duration of T₂ and T₃ is the same. The look-up table will in this case be based on empirical data for inputs sampled over the period of T₂+T₃.

Some electrical connections which are known in the prior art have been omitted in these drawings for clarity.

While the invention has been particularly shown and described with reference to various embodiments, it will be recognized by those skilled in the art that modifications and changes may be made to the present invention without departing from the spirit and scope thereof. The scope of the invention should therefore be determined not with reference to the above description but with reference to the appended claims along with their full scope of equivalents.

What is claimed is:

1. A method for assaying precious metal comprising the steps of:
(a) forming an electrolytic cell which includes an anode specimen and a reference cathode;
(b) driving a ramp input into the electrolytic cell;
(c) measuring a resulting current through the electrolytic cell generated by said ramp input; and
(d) determining an assay value for the specimen based on measurement of the resulting current.

2. The precious metal assay method claimed in claim 1, including the step of integrating said resulting current over a period of the ramp input to calculate the total electrical charge of the resulting current.

3. The precious metal assay method claimed in claim 2, wherein said total electrical charge is compared to a list of electrical charges of known precious metal compositions to determine said assay value.

4. The precious metal assay method claimed in claim 1, including the step of mapping out a resulting current response over the ramp input.

5. The precious metal assay method claimed in claim 4, wherein said assay value is determined by comparing the resulting current response against a list of current responses of known precious metal compositions by their localities.

6. The precious metal assay method claimed in claim 4, wherein said assay value is determined by interpolating a locality of the resulting current response situated between two listed regions to obtain a corresponding assay value.

7. The precious metal assay method claimed in claim 1, wherein said assay value is determined from a look-up table based on empirical data for known precious metal compositions.

8. The precious metal assay method claimed in claim 7, wherein said assay value is determined by interpolation of said look-up table values.

9. The precious metal assay method claimed in claim 1, wherein said step of driving a ramp input into the electrolytic cell comprises the step of ramping-up from an initial voltage which corresponds to a steady state open circuit voltage of the electrolytic cell.

10. The precious metal assay method claimed in claim 9, wherein said ramp input ramps up to a peak voltage and cuts off the ramp input thereafter.

11. The precious metal assay method claimed in claim 10, wherein said step of driving a ramp input into the electrolytic cell comprises the step of driving a ramp input for a duration of between about 5 to about 8 seconds.

12. The precious metal assay method claimed in claim 10, wherein said ramp input duration is about 7 seconds.

13. The precious metal assay method claimed in claim 1, wherein said ramp input comprises a voltage in a triangular-shaped waveform.

14. The precious metal assay method claimed in claim 10, wherein said ramp input includes a peak voltage in the range of about 4.5V to about 5.0V.

15. The precious metal assay method claimed in claim 10, wherein said ramp input includes a peak voltage of about 4.8V.

16. The precious metal assay method claimed in claim 1, wherein said step of driving a ramp input into the electrolytic cell comprises the step of ramping-up to a peak voltage and ramping down from said peak voltage.

17. The precious metal assay method claimed in claim 16, wherein said ramping-up and ramping down steps last for about 5 to about 8 seconds each.

18. The precious metal assay method claimed in claim 16, wherein said ramping-up and ramping down steps last for about 7 seconds each.

19. The precious metal assay method claimed in claim 16, wherein said ramp input comprises a voltage in a triangular-shaped waveform.

20. The precious metal assay method claimed in claim 16, wherein said ramp input includes a peak voltage which ranges about 4.5V to about 5.0V.

21. The precious metal assay method claimed in claim 16, wherein said ramp input includes a peak voltage of about 4.8V.

22. The precious metal assay method claimed in claim 1, wherein said electrolytic cell is switchable through a relay between a voltage driver for providing a ramp input and a microprocessor for determining an initial voltage for said ramp input based on a steady state open circuit voltage of said cell.

23. The precious metal assay method claimed in claim 1, wherein said step of measuring a resulting current through the electrolytic cell comprises the step of measuring said resulting current using a current measuring resistor coupled to a differential amplifier.

24. The precious metal assay method claimed in claim 1, wherein said step of forming an electrolytic cell comprises the steps of:
(a) contacting an anode probe to a first surface of a specimen under test to form the anode specimen; and
(b) dispensing a controlled amount of electrolytic gel onto a second surface of the specimen to electrically link the cathode probe to the specimen and the anode probe.

25. A method for assaying precious metal comprising the steps of:
(a) forming an electrolytic cell which includes an anode specimen and a reference cathode;
(b) driving a ramp input into the electrolytic cell;
(c) measuring a resulting current through the electrolytic cell generated by said ramp input to provide a resulting current response; and
(d) determining an assay value for the specimen based on the resulting current response;
wherein the assay value is determined by comparing the resulting current response against a list of current responses for known precious metal compositions by their slopes and peaks.

26. The precious metal assay method claimed in claim 25, wherein said assay value is determined by interpolating the slopes and peaks of the input current response against the slopes and peaks of the list of current responses.

27. The precious metal assay method claimed in claim 25, wherein said slope is based on a maximum slope of the current responses.

28. Precious metal assaying apparatus comprising:
an anode and a cathode for forming an electrolytic cell with a specimen that is to be assayed; and
electronic circuitry associated with said anode and cathode for determining an electrical characteristic of said cell;
wherein said testing circuitry comprises:
a driver for applying a ramp voltage to said cell; and
a monitoring circuit for measuring the resulting current flow through said cell during the application of said ramp voltage.

29. The apparatus of claim 28, wherein said testing circuitry includes circuitry for determining a steady-state open-circuit voltage of said cell, and for controlling said driver to ramp up from said steady-state open-circuit voltage.

30. The apparatus of claim 28, wherein said monitoring circuitry includes a current measuring resistor in series with said cell, and a differential amplifier coupled across said resistor.

31. The apparatus of any of claims 28, including a microprocessor and a relay for switching said cell between said microprocessor and said voltage driver;
wherein said microprocessor determines said steady-state open-circuit voltage when said relay is switched to said microprocessor;
wherein to apply said ramp voltage to said cell, said microprocessor instructs said relay to switch to said driver and instructs said voltage driver to output said ramp voltage; and
wherein said microprocessor receives said output from said differential amplifier and determines said assay value based on the measured current.
